(19) United States
(12) Patent Application Publication
(10) Pub. No.: US 2025/0282152 A1
(43) Pub. Date: Sep. 11, 2025

(54) CARRY CASE AND RECORDING SYSTEM

(71) Applicant: SEIKO EPSON CORPORATION, Tokyo (JP)

(72) Inventors: Shigeaki ISOBE, MATSUMOTO-SHI (JP); Nobuhisa NOMOTO, MATSUMOTO-SHI (JP); Yoshiyuki TANAKA, MATSUMOTO-SHI (JP)

(21) Appl. No.: 19/069,583

(22) Filed: Mar. 4, 2025

(30) Foreign Application Priority Data
Mar. 5, 2024 (JP) 2024-032759
Mar. 5, 2024 (JP) 2024-032760

(51) Int. Cl. B41J 3/36; B41J 3/54; B41J 29/06; B41J 29/13; B41J 29/17; B41J 29/19; B41J 29/393

(52) U.S. Cl. CPC B41J 3/36; B41J 3/543; B41J 29/06; B41J 29/13; B41J 29/17; B41J 29/19; B41J 29/393

(57) ABSTRACT

The carry case includes a housing main body; a first accommodation section configured to accommodate a plurality of recording devices in a state of being stacked in plurality of tiers in a vertical direction in the first accommodation region within the housing main body; a second accommodation section configured to accommodate the power supply device that supplies electric power to the plurality of recording devices in the second accommodation region within the housing main body; a first opening and closing door configured to open and close in a first surface; a second opening and closing door configured to open and close on a second surface; and a wheel configured to move the housing main body.

The present application is based on, and claims priority from JP Application Serial Number 2024-032759, filed Mar. 5, 2024, and from JP Application Serial Number 2024-032760, filed Mar. 5, 2024, the disclosures of which are hereby incorporated by reference herein in their entirety.

### BACKGROUND

### 1. Technical Field

The present disclosure relates to a carry case and a recording system.

### 2. Related Art

For example, JP-A-2021-87130 discloses a cabinet capable of accommodating a recording device that performs recording by ejecting liquid. A reading device and a projection device are installed in the cabinet, and it is possible to improve convenience for the user.

However, although the cabinet can accommodate the recording device, it is not easy to transport the cabinet with the recording device inside. As described above, it is desired to improve user convenience.

### SUMMARY

A carry case for solving the above problem includes a housing main body; a first accommodation section configured to accommodate, in a first accommodation region within the housing main body, a plurality of recording devices in a state of being stacked in a plurality of tiers in a vertical direction; a second accommodation section configured to accommodate, in the housing main body in a second accommodation region that is aligned in the vertical direction with the first accommodation region, a power supply device that supplies electric power to the plurality of recording devices; a first opening and closing door configured to open and close in a first surface of the housing main body; a second opening and closing door configured to open and close in a second surface opposite to the first surface of the housing main body; and a wheel that is below the housing main body and that enables moving the housing main body.

A carry case for solving the above problem includes a housing main body; a first accommodation section configured to accommodate a plurality of recording devices in a state of being stacked in a plurality of tiers in a vertical direction in a first accommodation region within the housing main body, the recording devices performing recording by ejecting liquid; a second accommodation section configured to accommodate, in the housing main body in a second accommodation region that is aligned in the vertical direction with the first accommodation region, a power supply device that supplies electric power to the plurality of recording devices; a wheel that is below the housing main body and that enables moving the housing main body; and a horizontal maintaining section configured to, when the housing main body is inclined at a predetermined angle, horizontally support the plurality of recording devices accommodated in the first accommodation section.

A recording system for solving the above problem includes a plurality of recording devices; a power supply device configured to supply power to the plurality of recording devices; and a carry case configured to accommodate the plurality of recording devices and the power supply device, wherein the carry case has a housing main body, a first accommodation section configured to accommodate the plurality of recording devices in a state of being stacked in a plurality of tiers in a vertical direction in the first accommodation region in the housing main body, a second accommodation section configured to house the power supply device in a second accommodation region aligned with the first accommodation region in the vertical direction in the housing main body, a first opening and closing door configured to open and close in a first surface of the housing main body, a second opening and closing door configured to open and close in a second surface opposite to the first surface of the housing main body, and a wheel that is below the housing main body and that enables moving the housing main body.

### BRIEF DESCRIPTION OF THE DRAWINGS

FIG. 1 is a perspective view showing a recording system according to the first embodiment.

FIG. 2 is a perspective view showing a recording system of the first embodiment.

FIG. 3 is a schematic diagram showing a recording system of the first embodiment.

FIG. 4 is a schematic diagram showing a recording system of the first embodiment.

FIG. 5 is a schematic diagram showing a recording system of the first embodiment.

FIG. 6 is a perspective view showing a recording device of the first embodiment.

FIG. 7 is a perspective view illustrating a recording device of the first embodiment.

FIG. 8 is a perspective view showing a recording device of the first embodiment.

FIG. 9 is a cross-sectional view showing a recording device of the first embodiment.

### DESCRIPTION OF EMBODIMENTS

### First Embodiment

Hereinafter, an embodiment of a recording system including a carry case will be described. In the following description, a direction intersecting the vertical direction Z is referred to as a widthwise direction X, and a direction intersecting the vertical direction Z and the widthwise direction X is referred to as a front-rear direction Y. One direction along the widthwise direction X is defined as the first widthwise direction X1, and the other direction along the widthwise direction X is defined as the second widthwise direction X2. One direction along the front-rear direction Y is referred to as the frontward direction Y1, and the other direction along the front-rear direction Y is referred to as the backward direction Y2. In the vertical direction Z, upward is referred to as the upward direction Z1, and downward is referred to as the downward direction Z2.

### Configuration of Recording System 10

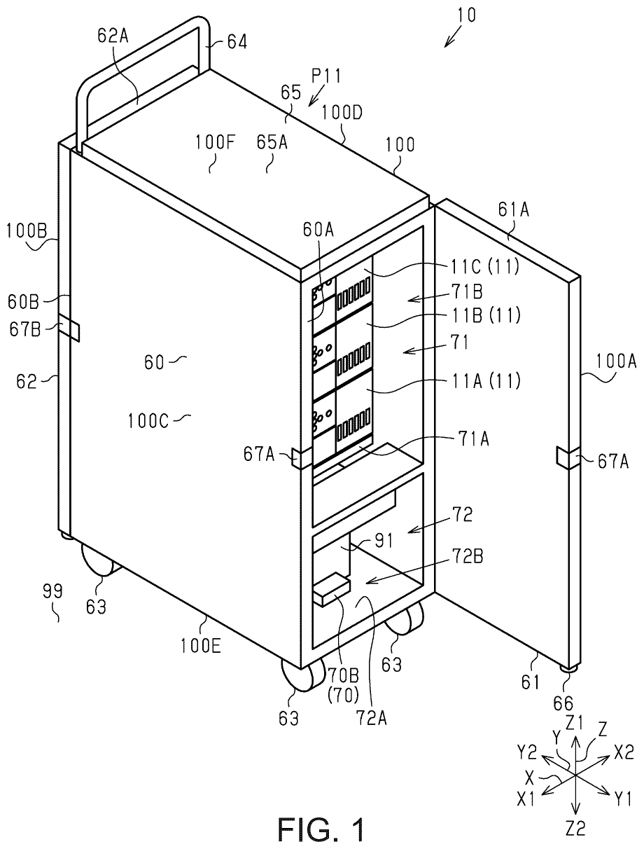

As shown in FIG. 1, a recording system 10 includes a carry case 100, a recording device 11, and a power supply device 91. The recording system 10 may include a plurality of recording devices 11. The recording system 10 may include a first recording device 11A, a second recording device 11B, and a third recording device 11C as the plurality of recording devices 11.

The plurality of recording devices 11 can be stacked in the plurality of tiers in the vertical direction Z. The plurality of recording devices 11 can be accommodated in the carry case 100 in a state of being stacked in the plurality of tiers in the vertical direction Z. The second recording device 11B is stacked in the upward direction Z1 of the first recording device 11A. The third recording device 11C is stacked in the upward direction Z1 of the second recording device 11B. The upper limit of the plurality of tiers is, for example, three tiers, but is not limited thereto.

The carry case 100 can accommodate the recording device 11 and the power supply device 91. The carry case 100 can accommodate the plurality of recording devices 11 and the power supply device 91. The carry case 100 can be carried in a state in which the plurality of recording devices 11 and the power supply device 91 are accommodated. The recording device 11 may be accommodated in the carry case 100 such that a front surface 12 faces the frontward direction Y1 and a rear surface 13 faces the backward direction Y2.

The recording device 11 is configured to record an image on a medium. The recording device 11 may be configured to record an image on a medium by ejecting a liquid onto the medium. The liquid, for example, may be ink. That is, the recording device 11 may be an inkjet type printer. The liquids may have, for example, a plurality of colors type or just mono color type. The medium may be, for example, paper sheet. The recording device 11 may be a device capable of performing recording on a plurality of types of paper sheets.

The power supply device 91 supplies power to the recording device 11. The power supply device 91 supplies power to the plurality of recording devices 11. The power supply device 91 is configured to be portable. The power supply device 91 may be a portable power source. The power supply device 91 can be accommodated in the carry case 100.

### Configuration of Carry Case 100

The carry case 100 may be configured to be in the shape of a rectangular parallelepiped. The carry case 100 is constructed in a rectangular parallelepiped shape that is longer in the front-rear direction Y than in the widthwise direction X. However, it is not limited to this configuration, and, for example, it may also be constructed in a rectangular parallelepiped shape that is longer in the widthwise direction X than in the front-rear direction Y.

The carry case 100 may include a case front surface 100A, a case rear surface 100B, a case left side surface 100C, a case right side surface 100D, a case bottom surface 100E, and a case top surface 100F. The case front surface 100A corresponds to an example of a first surface. The case rear surface 100B corresponds to an example of a second surface.

The carry case 100 includes a housing main body 60, a first opening and closing door 61, a second opening and closing door 62, wheels 63, a grip section 64, and a table 65. The housing main body 60 may be constructed in a rectangular parallelepiped shape.

The housing main body 60 includes a first opening section 60A and a second opening section 60B. The first opening section 60A is provided in the frontward direction Y1. The first opening section 60A can be opened and be closed by the first opening and closing door 61. The second opening section 60B is provided in the backward direction Y2. The second opening section 60B can be opened and be closed by the second opening and closing door 62.

### Configuration of First Accommodation Section 71 and Second Accommodation Section 72

The housing main body 60 includes a first accommodation section 71 and a second accommodation section 72. That is, the carry case 100 includes the first accommodation section 71 and the second accommodation section 72. The first accommodation section 71 and the second accommodation section 72 are provided in the housing main body 60. The first accommodation section 71 and the second accommodation section 72 are positioned to be aligned in the vertical direction Z. The first accommodation section 71 may be positioned in the upward direction Z1 of the second accommodation section 72.

The first accommodation section 71 can accommodate the plurality of recording devices 11 in a state of being stacked in plurality of tiers in the vertical direction Z. The first accommodation section 71 includes a first placement section 71A and a first accommodation region 71B. The first placement section 71A is provided within the housing main body 60. The recording device 11 can be placed on the first placement section 71A. The first placement section 71A can support the plurality of recording devices 11 in a stacked state in plurality of tiers in the vertical direction Z. The first placement section 71A may have a flat-plate shape.

The first accommodation region 71B is provided within the housing main body 60. The first accommodation region 71B is a region where the recording device 11 can be accommodated. The first accommodation region 71B is the region where the plurality of recording devices 11 can be accommodated in a state of being stacked in the plurality of tiers in the vertical direction z.

The second accommodation section 72 can accommodate the power supply device 91 in the housing main body 60. The second accommodation section 72 includes a second placement section 72A and a second accommodation region 72B. The second placement section 72A is provided within the housing main body 60. The power supply device 91 can be placed on the second placement section 72A. The second placement section 72A may have a flat-plate shape. The second placement section 72A may be a bottom plate of the housing main body 60.

The second accommodation region 72B is provided within the housing main body 60. The second accommodation region 72B is a region aligned with the first accommodation region 71B in the vertical direction Z. The second accommodation region 72B is a region capable of housing the power supply device 91.

### Configuration of First Opening and Closing Door 61 and Second Opening and Closing Door 62

The first opening and closing door 61 is provided in the frontward direction Y1 of the housing main body 60. The first opening and closing door 61 may constitute the case front surface 100A. The first opening and closing door 61 can open and close the first opening section 60A in the case front surface 100A. The first opening and closing door 61 may be rotatable about a first rotation shaft along the vertical direction Z. The first rotation shaft may be provided at the second widthwise direction X2 side of the carry case 100.

When the first opening and closing door 61 is opened, the first accommodation section 71 and the second accommodation section 72 can be accessed from the frontward direction Y1. That is, the first opening and closing door 61 can open and close the first accommodation region 71B and the second accommodation region 72B in the frontward direction Y1.

The second opening and closing door 62 is provided in the backward direction Y2 of the housing main body 60. The second opening and closing door 62 may constitute the case rear surface 100B. The second opening and closing door 62 can open and close the second opening section 60B in the case rear surface 100B. The second opening and closing door 62 may be rotatable about a second rotation shaft along the vertical direction Z. The second rotation shaft may be provided on the second widthwise direction X2 side of the carry case 100.

When the second opening and closing door 62 is opened, the first accommodation section 71 and the second accommodation section 72 can be accessed from the backward direction Y2. That is, the second opening and closing door 62 can open and close the first accommodation region 71B and the second accommodation region 72B in the backward direction Y2.

The wheels 63 are provided in the downward direction Z2 from the housing main body 60. The wheels 63 can be placed on an installation surface 99. When the carry case 100 is arranged horizontally, all of the wheels 63 are arranged on the installation surface 99. When the carry case 100 is positioned so as to be inclined, some of the wheels 63 are positioned on the installation surface 99.

The wheels 63 enable the housing main body 60 to move. That is, the wheels 63 allow the carry case 100 to be movable. The wheels 63 may move the carry case 100 by a driving force from a drive section 69 (to be described later).

The grip section 64 can be gripped by a user. The grip section 64 can be gripped when the carry case 100 is handled by the user. The grip section 64 is located on the backward direction Y2 side of the housing main body 60. The grip section 64 is located on the upward direction Z1 of the housing main body 60. The grip section 64 may be expanded and contracted so it can be housed in the housing main body 60. In particular, when the user moves the carry case 100, the grip section 64 can be gripped in a state where the grip section 64 is extended to the upward direction Z1 and the carry case 100 is inclined to the backward direction Y2.

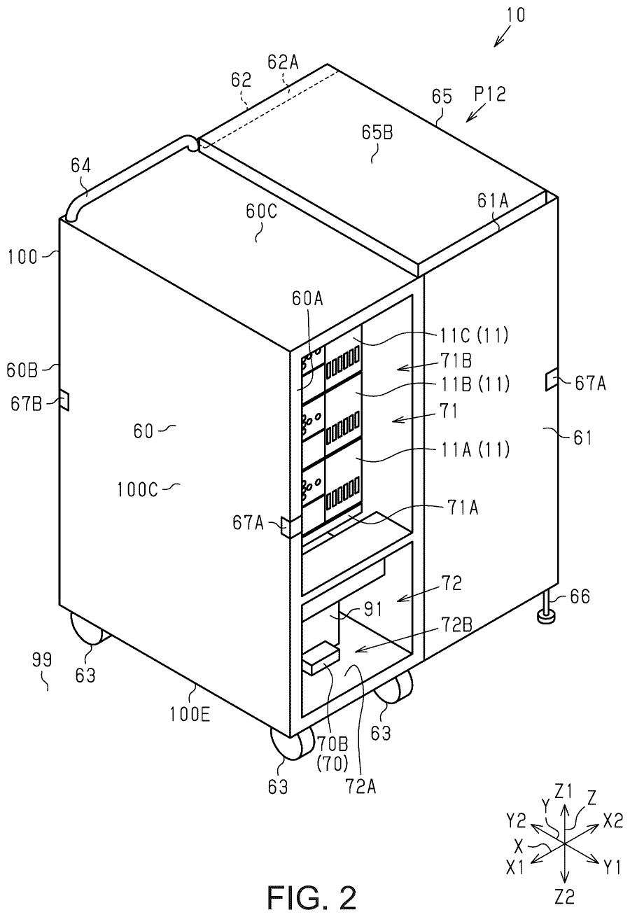

As shown in FIGS. 1 and 2, the table 65 is provided in the upward direction Z1 of the housing main body 60. The table 65 can be displaced between a storage position P11 shown in FIG. 1 and an expansion position P12 shown in FIG. 2. In other words, the table 65 is deployable from the storage position P11 to the expansion position P12. The table 65 may be displaceable between the storage position P11 and the expansion position P12 by rotating about a third rotation shaft that extends along the front-rear direction Y on the second widthwise direction X2 side of the housing main body 60.

As shown in FIG. 1, the storage position P11 is a position at which table 65 is disposed in the upward direction Z1 of the housing main body 60. The storage position P11 is a position at which a first placement surface 65A of the table 65 is exposed in the upward direction Z1. The first placement surface 65A may constitute the case top surface 100F when arranged at the storage position P11.

An object to be placed can be placed on the first placement surface 65A. The object to be placed may be, for example, a laptop computer, a tablet terminal device, or a portable terminal device. The object to be placed may be capable of communicating with the recording device 11. The object to be placed may be supplied with power from the power supply device 91.

As shown in FIG. 2, the expansion position P12 is a position at which the table 65 is disposed further in the widthwise direction X than the housing main body 60. The expansion position P12 is a position at which a second placement surface 65B of the table 65 is exposed to the upward direction Z1. The second placement surface 65B is the back surface of the first placement surface 65A. An object to be placed can be placed on the second placement surface 65B. That is, when the table 65 is expanded to the expansion position P12, the object to be placed can be placed on the second placement surface 65B. The second placement surface 65B corresponds to an example of a placement surface. The expansion position P12 is a position at which a housing top surface 60C of the housing main body 60 is exposed to the upward direction Z1. An object to be placed can be placed on the housing top surface 60C.

When the table 65 is expanded to the expansion position P12, the table 65 is supported by the opened first opening and closing door 61 and the second opening and closing door 62. In detail, when the table 65 is extended to the expansion position P12, the table 65 is supported by a first top end section 61A of the opened first opening and closing door 61 and a second top end section 62A of the opened second opening and closing door 62.

The carry case 100 may include an adjuster 66. The adjuster 66 is provided in the downward direction Z2 from the first opening and closing door 61. The adjuster 66 may be provided in the downward direction Z2 from the first opening and closing door 61 on the first widthwise direction X1 side when the first opening and closing door 61 is closed. In this way, the adjuster 66 may be provided on the side opposite from the first rotation shaft of the first opening and closing door 61 in the widthwise direction X.

The adjuster 66 is provided in the downward direction z2 from the second opening and closing door 62. The adjuster 66 may be provided in the downward direction Z2 on the first widthwise direction X1 side of the second opening and closing door 62 when the second opening and closing door 62 is closed. In this way, the adjuster 66 may be provided on the side opposite to the second rotation shaft of the second opening and closing door 62 in the widthwise direction X.

The height of the adjuster 66 in the vertical direction Z can be adjusted. Thus, when the table 65 is expanded to the expansion position P12, the height of the adjuster 66 can be adjusted in the downward direction 22 of the first opening and closing door 61. The adjuster 66 is configured to support the first opening and closing door 61 from the downward direction 22 by adjusting the height when the table 65 is expanded to the expansion position P12.

When the table 65 is expanded to the expansion position P12, the height of the adjuster 66 can be adjusted in the downward direction 22 of the second opening and closing door 62. The adjuster 66 is configured to support the second opening and closing door 62 from the downward direction 22 by adjusting the height when the table 65 is expanded to the expansion position P12.

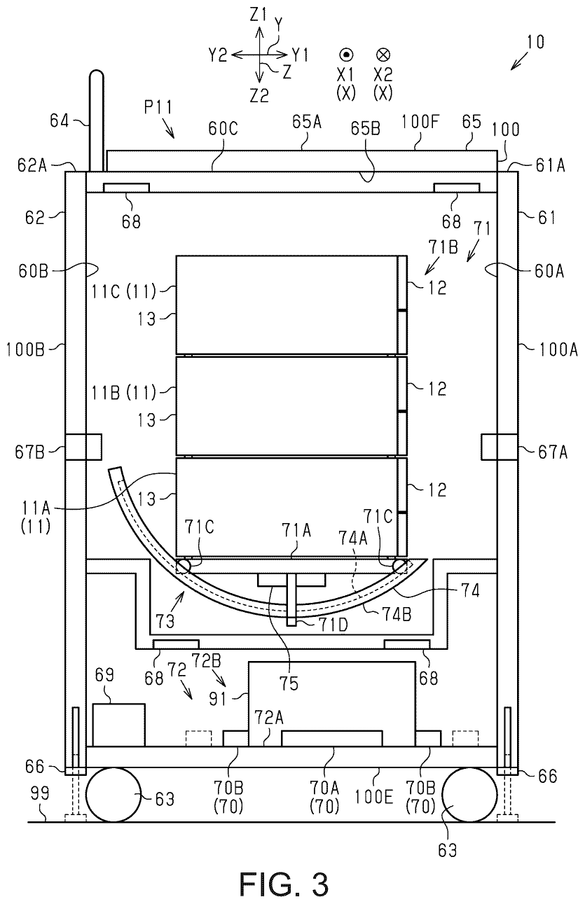

As shown in FIG. 3, the carry case 100 may include a first locking section 67A and a second locking section 67B. The first locking section 67A is provided in the housing main body 60 and the first opening and closing door 61. The first locking section 67A locks the first opening and closing door 61 in a state where the first opening and closing door 61 is closed. The second locking section 67B is provided on the housing main body 60 and the second opening and closing door 62. The second locking section 67B locks the second opening and closing door 62 in a state where the second opening and closing door 62 is closed.

The carry case 100 may include an illumination section 68. The illumination section 68 is provided in the housing main body 60. The illumination section 68 illuminates the inside of the housing main body 60. The illumination section 68 may illuminate the first accommodation region 71B. The illumination section 68 may illuminate the second accommodation region 72B.

The carry case 100 may include the drive section 69. The drive section 69 can be housed in the second accommodation section 72. The drive section 69 is fixed to the second accommodation section 72. The drive section 69 is configured to drive the wheels 63. The drive section 69 is a driving source that drives the wheels 63 by supplying a driving force to the wheels 63. The drive section 69 may be a driving source that drives the wheels 63 located in the backward direction Y2. The drive section 69 may be a motor.

The carry case 100 may include a first fixing section 70. The first fixing section 70 is provided on the second placement section 72A. That is, the second accommodation section 72 may include the first fixing section 70. Even when the housing main body 60 is inclined at a predetermined angle, the first fixing section 70 fixes the position of the power supply device 91 placed on the second placement section 72A.

The first fixing section 70 may include a first member 70A that fixes the position of the power supply device 91 placed on the second placement section 72A in the widthwise direction X. The first member 70A is displaceable in the widthwise direction X in accordance with the dimension of the power supply device 91 in the widthwise direction X. The first member 70A can be fixed at an arbitrary position to be displaced in the widthwise direction X.

The first fixing section 70 may include a second member 70B that fixes the position of the power supply device 91 placed on the second placement section 72A in the front-rear direction Y. The second member 70B is displaceable in the front-rear direction Y in accordance with the dimension of the power supply device 91 in the front-rear direction Y. The second member 70B can be fixed at any position where it is displaced in the front-rear direction Y.

### Configuration of Horizontal Maintaining Section 73

The carry case 100 includes a horizontal maintaining section 73. The horizontal maintaining section 73 is configured to maintain horizontal the plurality of recording devices 11 accommodated in the first accommodation section 71 when the housing main body 60 is inclined at a predetermined angle. The predetermined angle may be, for example, an angle larger than 0 degrees and smaller than 30 degrees with respect to the backward direction Y2. That is, the predetermined angle may be an angle inclined with respect to the backward direction Y2. The horizontal maintaining section 73 does not horizontally maintain the power supply device 91 accommodated in the second accommodation section 72 when the housing main body 60 is inclined at a predetermined angle.

The horizontal maintaining section 73 includes a guide section 74. The guide section 74 is fixed to the housing main body 60. The guide section 74 may have a circular arc shape about an axis along the widthwise direction X. When the carry case 100 is arranged horizontally, the guide section 74 may extend to the same height as the top surface of the first placement section 71A in the frontward direction Y1. In this manner, the guide section 74 is extended to a position lower than the plurality of recording devices 11 stacked on the first placement section 71A in the frontward direction Y1.

In a case where the carry case 100 is horizontally arranged, the guide section 74 may extend to a position higher than the top surface of the first placement section 71A on the backward direction Y2. In this manner, the guide section 74 is extended to a position higher than the plurality of recording devices 11 stacked on the first placement section 71A in the backward direction Y2. The guide section 74 guides the first placement section 71A so as to maintain the first placement section 71A horizontally.

The guide section 74 may include a guide groove 74A. The guide groove 74A is provided on the inner peripheral side of the guide section 74. The guide groove 74A is slidable on a rotator 71C provided on the first placement section 71A. The rotator 71C may be, for example, a roller. The guide groove 74A is provided at a position corresponding to the movement range of the first placement section 71A. In this manner, the guide section 74 guides the first placement section 71A so as to maintain the horizontal of the first placement section 71A by rotating the first placement section 71A about an axis along the widthwise direction X.

An outer peripheral section 74B of the guide section 74 is slidable with a sliding portion 71D provided on the first placement section 71A. For this reason, even when the carry case 100 receives vibration in the vertical direction Z, the sliding portion 71D comes into contact with the outer peripheral section 74B, and thus the first placement section 71A can maintain a certain distance without being separated from the guide section 74. That is, it is configured so that the distance between the guide section 74 and the first placement section 71A is maintained within the permissible range. The permissible range may be a range in which the first placement section 71A is not separated from the guide section 74 and is not affected by the vibration.

The horizontal maintaining section 73 may include a second fixing section 75. That is, the carry case 100 may include the second fixing section 75. The second fixing section 75 is arranged in the housing main body 60. In a case where the housing main body 60 is arranged horizontally, the second fixing section 75 is configured to be insertable and removable by a user's operation on the bottom surface of the first placement section 71A.

When the housing main body 60 is arranged horizontally, the second fixing section 75 is arranged so as to support the bottom surface of the first placement section 71A, thereby fixing the first placement section 71A horizontally. By this, in a case where the housing main body 60 is arranged horizontally, the second fixing section 75 fixes the plurality of recording devices 11 accommodated in the first accommodation section 71 so as to be maintained horizontally. When the housing main body 60 is arranged horizontally, the second fixing section 75 is arranged so as not to support the bottom surface of the first placement section 71A, thereby releasing the fixing of the first placement section 71A.

### Posture of Carry Case 100

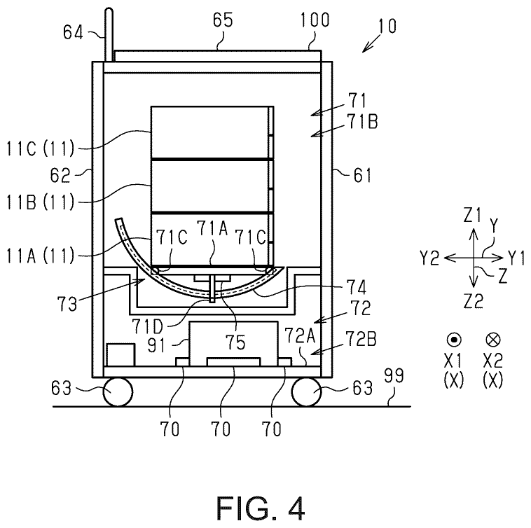

As shown in FIG. 4, in a case where the second fixing section 75 horizontally fixes the first placement section 71A in a state where the housing main body 60 is horizontally arranged, the plurality of recording devices 11 accommodated in the first accommodation section 71 are horizontally fixed. By this, it is possible to perform recording with the recording device 11 in a stable state.

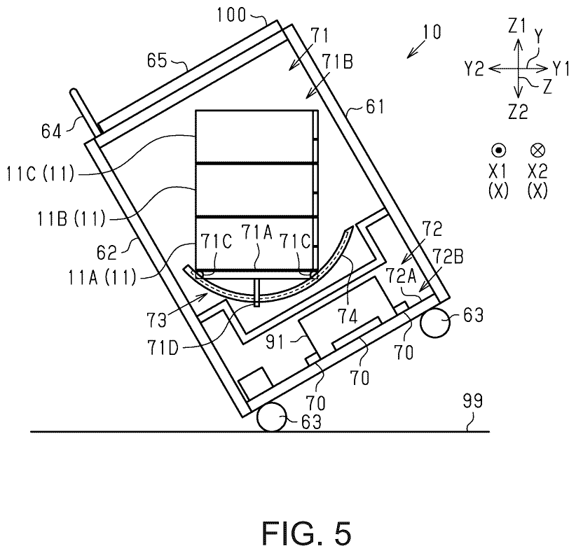

As shown in FIG. 5, after the fixation of the first placement section 71A by the second fixing section 75 is released, when the housing main body 60 is inclined during the transport of the carry case 100, the first placement section 71A is guided by the guide section 74 so as to be maintained horizontal. By this, the horizontal maintaining section 73 can horizontally maintain the plurality of recording devices 11 accommodated in the first accommodation section 71.

The power supply device 91 is fixed to the second placement section 72A by the first fixing section 70. By this, even if the power supply device 91 is not maintained horizontally, the power supply device 91 is stably accommodated in the second accommodation section 72.

### Configuration of Recording Device 11

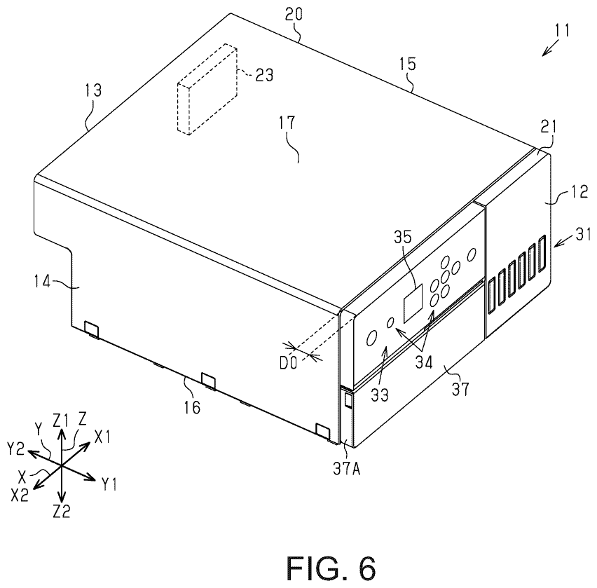

As shown in FIG. 6, the recording device 11 is constructed in a rectangular parallelepiped shape. The recording device 11 has the front surface 12. The front surface 12 is a plane facing the frontward direction Y1. The recording device 11 has the rear surface 13. The rear surface 13 is a flat surface facing the backward direction Y2. The recording device 11 has a left side surface 14. The left side surface 14 is a flat surface facing the second widthwise direction X2. The recording device 11 has a right side surface 15. The right side surface 15 is a flat surface facing the first widthwise direction X1. The recording device 11 has a bottom surface 16. The bottom surface 16 is a flat surface facing the downward direction Z2. The recording device 11 has a top surface 17. The top surface 17 is a flat surface facing the upward direction Z1.

As described above, the top surface 17 includes a flat surface on which the placed object can be placed. The placed object may be another recording device 11 or may be a laptop computer. The top surface 17 may be entirely flat in the region or may include non-flat areas in the region, provided that there is a flat portion where the placed object can be placed.

The recording device 11 includes a housing 20 and a main body 21. The housing 20 is configured to accommodate the main body 21. The housing 20 constitutes at least a part of the left side surface 14, a part of the right side surface 15, a part of the bottom surface 16, and a part of the top surface 17 of the recording device 11. However, the housing 20 may also constitute at least the entire left side surface 14, the entire right side surface 15, the entire bottom surface 16, and the entire top surface 17 of the recording device 11.

As described above, the housing 20 has a plurality of surfaces such as the left side surface 14, the right side surface 15, the bottom surface 16, and the top surface 17 of the recording device 11. It can be said that the left side surface 14, the right side surface 15, the bottom surface 16, and the top surface 17 of the recording device 11 are the left side surface, the right side surface, the bottom surface, and the top surface of the housing 20, respectively. At least a part of the front surface 12 of the recording device 11 may be included in the housing 20. Further, at least a part of the rear surface 13 of the recording device 11 may be included in the housing 20.

The main body 21 constitutes at least the entire front surface 12 of the recording device 11 but may constitute at least a part of the front surface 12 of the recording device 11. Thus, the main body 21 has the front surface 12 of the recording device 11. It can be said that the front surface 12 of the recording device 11 is the front surface of the main body 21. In addition, the rear surface 13 of the recording device 11 may be constituted by the rear surface of the housing 20 and the rear surface of the main body 21, may be constituted by only the rear surface of the housing 20, or may be constituted by only the rear surface of the main body 21.

The recording device 11 includes a contained-amount visual check section 31. The contained-amount visual check section 31 is provided in the main body 21. The contained-amount visual check section 31 can be used to visually check a contained amount of liquid in a liquid container 40 (to be described later). The contained-amount visual check section 31 includes a plurality of visual check windows respectively corresponding to the liquid of the respective colors.

The recording device 11 includes an operation panel 33. The operation panel 33 is provided on the main body 21. The operation panel 33 includes an operation section 34 and a display section 35. The operation section 34 can be operated by a user. The operation section 34 may include a plurality of operation buttons. The display section 35 displays information related to the recording device 11. The operation panel 33 is positioned on the front surface 12 of the recording device 11.

The main body 21 is configured to be displaceable along the front-rear direction Y with respect to the housing 20. In detail, the main body 21 is configured to be displaceable between a closed position, a first open position, and a second open position along the front-rear direction Y with respect to the housing 20.

The main body 21 can be positioned at a closed position. The closed position is a position at which the main body 21 is accommodated in the housing 20. The closed position is a position at which the main body 21 protrudes from the housing 20 by a predetermined distance DO toward the frontward direction Y1. However, the main body 21 may be a position at which it does not protrude from the housing 20. That is, the main body 21 constitutes a part of the left side surface 14, a part of the right side surface 15, a part of the bottom surface 16, and a part of the top surface 17 of the recording device 11. However, the main body 21 may not constitute the entire left side surface 14, the right side surface 15, the bottom surface 16, and the top surface 17 of the recording device 11.

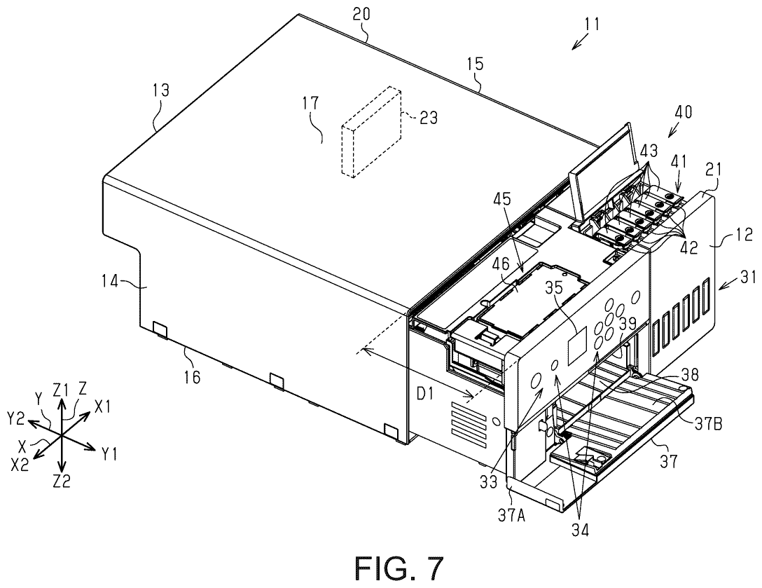

As shown in FIG. 7, the main body 21 can be displaced to the first open position. The first open position is an open position at which the main body 21 protrudes from the housing 20 toward the frontward direction Y1. In particular, the first open position is a position at which the main body 21 protrudes from the housing 20 toward the frontward direction Y1 by a first distance D1. The first distance D1 is longer than the predetermined distance DO. In this way, when the main body 21 is arranged at the first open position, at least a part of the interior of the main body 21 is exposed from the housing 20.

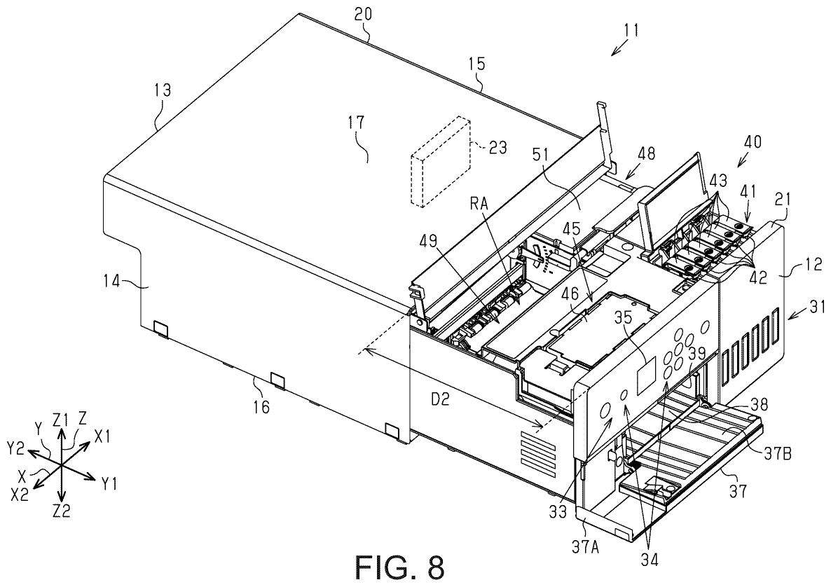

As shown in FIG. 8, the main body 21 can be displaced to the second open position. The second open position is an open position at which the main body 21 protrudes from the housing 20 toward the frontward direction Y1. In particular, the second open position is a position at which the main body 21 protrudes from the housing 20 toward the frontward direction Y1 by a second distance D2. The second distance D2 is longer than the first distance D1. In this way, when the main body 21 is arranged at the second open position, at least a part of the interior of the main body 21 is exposed from the housing 20.

The recording device 11 includes a control section 23. The control section 23 is mounted on the main body 21. The control section 23 is housed in the housing 20. The control section 23 is not exposed from the housing 20 when the main body 21 is positioned at the closed position, the first open position, and the second open position.

The control section 23 controls the recording device 11. The control section 23 controls various operations performed by the recording device 11. The control section 23 can be configured as a circuit including a: one or more processors that execute various processes in accordance with a computer program, B: one or more dedicated hardware circuits that execute at least some of the various processes, or y: a combination thereof. The hardware circuit is, for example, an application-specific integrated circuit. The processor includes a CPU and memory, such as RAM and ROM, and the memory stores program code or commands configured to cause the CPU to perform processes. The memory, in other words, computer-readable medium, includes any readable medium that can be accessed by a general purpose or special purpose computer.

The recording device 11 includes an opening and closing section 37. The opening and closing section 37 is arranged in the main body 21. The opening and closing section 37 is positioned on the front surface 12 of the recording device 11. The opening and closing section 37 is configured to be rotatable around a rotation shaft along the widthwise direction X at a lower end portion 37A. By this, the opening and closing section 37 is configured to open and close with respect to the front surface 12 of the recording device 11.

The recording device 11 includes a discharge port 38. The discharge port 38 is provided in the main body 21. The discharge port 38 is an opening for discharging a medium on which recording is performed by a recording section 48 (to be described later). The discharge port 38 is opened in the frontward direction Y1 of the recording device 11. That is, the discharge port 38 is provided so as to be opened to the frontward direction Y1 in the front surface 12 of the recording device 11. In other words, the discharge port 38 is provided on the front surface of the main body 21 so as to open to the frontward direction Y1.

The discharge port 38 is exposed in the frontward direction Y1 of the recording device 11 when the opening and closing section 37 is open. The discharge port 38 is not exposed when the opening and closing section 37 is closed. However, the discharge port 38 may be exposed even when the opening and closing section 37 is closed. The discharge port 38 is positioned in the second widthwise direction X2 of the liquid container 40 (to be described later).

The recording device 11 includes a sheet discharge tray 37B. The sheet discharge tray 37B is provided in the main body 21. The sheet discharge tray 37B is provided on an inner wall surface of the opening and closing section 37. The sheet discharge tray 37B is exposed when the opening and closing section 37 is opened, and a medium after recording can be placed thereon. The sheet discharge tray 37B may be configured to expand and contract in the front-rear direction Y.

The recording device 11 includes a device-grip section 39. The device-grip section 39 is provided in the main body 21. The device-grip section 39 is provided in the upward direction Z1 of the discharge port 38. The device-grip section 39 is provided at a position on the front surface 12 of the recording device 11 where it can be gripped by the user from the frontward direction Y1. That is, the device-grip section 39 is provided at a position where the user can grip the grip section from the frontward direction Y1 on the side of the surface facing the frontward direction Y1 of the main body 21. In this way, the device-grip section 39 can be gripped by the user when the main body 21 is displaced in the front-rear direction Y. In particular, even when the plurality of recording devices 11 are stacked in the vertical direction Z or the plurality of recording devices 11 are installed side by side in the widthwise direction X, the device-grip section 39 can be easily gripped by the user from the frontward direction Y1 side.

As shown in FIG. 7, the recording device 11 includes the liquid container 40. The liquid container 40 is mounted on the main body 21. The liquid container 40 is configured to contain liquid used for recording on a medium. In other words, the liquid container 40 is configured to contain a liquid to be supplied to the recording section 48 (to be described later). The liquid container 40 may be a tank-type container into which liquid can be poured or may be a cartridge-type container which can be attached to and detached from the recording device 11.

The liquid container 40 includes an accommodation chamber 41, a liquid inlet 42, and a cap 43. The accommodation chamber 41 is configured to accommodate a liquid. The liquid inlet 42 is an opening through which liquid can be poured into the accommodation chamber 41. The cap 43 covers the liquid inlet 42. The cap 43 can suppress drying in the accommodation chamber 41 by sealing the accommodation chamber 41. By removing the cap 43 from the liquid inlet 42, the liquid can be poured via the liquid inlet 42 into the accommodation chamber 41. The liquid container 40 may include a plurality of accommodation chambers 41, a plurality of liquid inlets 42, and a plurality of caps 43 corresponding to the respective colors.

The liquid container 40 is not exposed from the housing 20 when the main body 21 is positioned at the closed position. The liquid container 40 is exposed from the housing 20 when the main body 21 is positioned at the first open position. In this way, when the main body 21 is positioned at the first open position, by removing the cap 43, the liquid inlet 42 is exposed from the housing 20. By this, the liquid can be poured via the liquid inlet 42 into the accommodation chamber 41. The liquid container 40 is also exposed from the housing 20 when the main body 21 is positioned at the second open position.

The recording device 11 includes a waste liquid mount section 45. The waste liquid mount section 45 is configured to allow a waste liquid container 46 to be mounted. The waste liquid container 46 is configured to be able to collect liquid discharged as waste liquid from the recording section 48 (to be described later) via a maintenance device (not shown). The waste liquid mount section 45 is mounted on the main body 21. The waste liquid mount section 45 is provided in the upward direction Z1 of the discharge port 38.

The waste liquid mount section 45 is not exposed from the housing 20 when the main body 21 is disposed at the closed position. The waste liquid mount section 45 is exposed from the housing 20 when the main body 21 is positioned at the first open position. In this way, when the main body 21 is disposed at the first open position, the waste liquid mount section 45 is exposed from the housing 20. By this, the waste liquid container 46 can be attached to and detached from the waste liquid mount section 45. The waste liquid mount section 45 is also exposed from the housing 20 when the main body 21 is positioned at the second open position.

As shown in FIG. 8, the recording device 11 includes the recording section 48. The recording section 48 is configured to perform recording on a medium. The recording section 48 may be configured to perform recording on a medium by ejecting liquid onto the medium. The recording section 48 is mounted on the main body 21. The recording section 48 is provided at a position adjacent to the liquid container 40 in the front-rear direction Y. The recording section 48 is provided in the backward direction Y2 of the liquid container 40.

The recording section 48 is exposed from the housing 20 when the main body 21 is positioned at the second open position. In particular, a carriage 51 (to be described later) is exposed from the housing 20 when the main body 21 is positioned at the second open position. The recording section 48 is not exposed from the housing 20 when the main body 21 is positioned at the closed position and the first open position.

The recording device 11 includes a transport path 49. The transport path 49 is a path for transporting a medium. The transport path 49 is provided in the main body 21. A part of the transport path 49 is exposed from the housing 20 when the main body 21 is positioned at the second open position. In particular, in the transport path 49, a recording region RA where the recording section 48 performs recording on the medium is exposed from the housing 20 when the main body 21 is positioned at the second open position. A portion of the transport path 49 is not exposed from the housing 20 when the main body 21 is positioned at the closed position and the first open position.

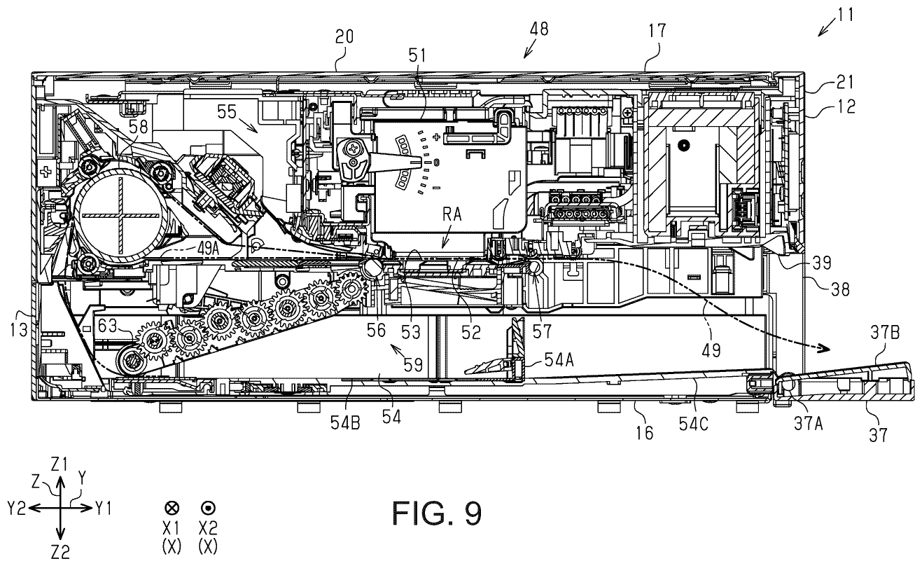

As illustrated in FIG. 9, the recording section 48 includes the carriage 51 and a liquid ejection head 52. The carriage 51 supports the liquid ejection head 52 from the upward direction Z1. The liquid ejection head 52 is provided in the downward direction 22 from the carriage 51. That is, the liquid ejection head 52 is mounted on the carriage 51.

The liquid ejection head 52 includes a plurality of nozzles (not shown). Each of the plurality of nozzles is opened toward the medium supported by a support section 53 (to be described later). Each of the plurality of nozzles ejects a liquid. The liquid ejection head 52 ejects liquid from the plurality of nozzles toward the medium supported by the support section 53. As described above, the recording section 48 is configured to perform recording on a medium by ejecting liquid onto the medium. The liquid ejection head 52 is a serial head type which ejects liquid in accordance with the movement of the carriage 51 in the widthwise direction X but may be a line head type.

The recording device 11 includes the support section 53. The support section 53 is mounted on the main body 21. The support section 53 is configured to support a medium. In particular, the support section 53 supports the medium in a recording region RA in which recording is performed on the medium by the recording section 48.

The recording device 11 includes a medium placement section 54. One or several media can be placed on the medium placement section 54. The medium placement section 54 may be a tray on which a medium can be placed. The medium placement section 54 is mounted on the main body 21. The medium placement section 54 can be displaced from the main body 21 along the front-rear direction Y. By being pulled out from the main body 21 to the frontward direction Y1, the medium placement section 54 is in a state in which medium can be placed thereon or taken out therefrom. In this way, the frontward direction Y1 corresponds to an example of a pull-out direction in which the medium placement section 54 is pulled out.

The medium placement section 54 includes a partition 54A. The partition 54A is positioned at the center of the medium placement section 54 in the front-rear direction Y. The partition 54A partitions the medium placement section 54 in the front-rear direction Y. The medium placement section 54 includes a first medium placement section 54B. The medium placement section 54 may include a second medium placement section 54C. The first medium placement section 54B and the second medium placement section 54C are regions partitioned in the front-rear direction Y by the partition 54A. The first medium placement section 54B is positioned further in the backward direction Y2 than the second medium placement section 54C. The first medium placement section 54B can accommodate one or more media before reading. One or more media after reading can be placed on the second medium placement section 54C.

The recording device 11 includes a medium feeding section 59. The medium feeding section 59 is positioned in the upward direction Z1 of the medium placement section 54 when the medium placement section 54 is mounted to the main body 21. More specifically, the medium feeding section 59 is positioned in the upward direction Z1 of the first medium placement section 54B when the medium placement section 54 is installed in the main body 21. The medium feeding section 59 feeds the medium placed on the medium placement section 54 one by one.

The recording device 11 includes a transport section 55. The transport section 55 is configured to transport a medium. The transport section 55 is mounted on the main body 21. The transport section 55 transports the medium fed by the medium feeding section 59 along the transport path 49.

The transport section 55 includes a plurality of rollers and plurality of motors serving as driving sources. In particular, the transport section 55 includes a transport roller pair 56. The transport roller pair 56 is positioned upstream of the transport path 49 of the support section 53. The transport roller pair 56 transports the medium to the support section 53 along the transport path 49. The transport section 55 includes a discharge roller pair 57. The discharge roller pair 57 is positioned downstream of the transport path 49 of the support section 53. The discharge roller pair 57 discharges the medium after recording along the transport path 49.

In this way, the medium placed on the medium placement section 54 is fed by the medium feeding section 59. Then, the medium fed by the medium feeding section 59 is transported along the transport path 49 by the transport section 55. By this, the recording section 48 performs recording on the medium transported along the transport path 49 by the transport section 55. That is, the recording section 48 performs recording on the medium fed by the medium feeding section 59.

The transport section 55 includes an inversion section 58. That is, the inversion section 58 is mounted on the main body 21. In addition, the recording device 11 includes the inversion section 58. The inversion section 58 may be configured to be attachable to and detachable from the main body 21 from the backward direction Y2. The inversion section 58 includes the plurality of rollers. The inversion section 58 is configured to transport a medium along the transport path 49.

The transport path 49 includes an inversion path 49A. The inversion path 49A is a path coupling the transport roller pair 56 and the inversion section 58. The inversion path 49A extends along the front-rear direction Y. After recording is performed on the front surface of the medium by the recording section 48 in the recording region RA, the transport roller pair 56 transports the medium to the inversion section 58 along the inversion path 49A. The inversion section 58 is configured to transport the medium along the transport path 49 in a state where the medium transported along the inversion path 49A is inverted. That is, the inversion section 58 inverts the medium fed by the medium feeding section 59.

In this way, the medium inverted by the inversion section 58 is transported to the recording region RA again, and thus the recording section 48 can perform recording on the back surface of the medium. By this, the recording section 48 can print on both sides of the medium. That is, the recording section 48 can perform recording after the medium is inverted by the inversion section 58. In particular, the recording section 48 may be able to record on double-sided printable photo paper sheet as a medium.

The inversion section 58 is detachably attached on the main body 21. The inversion section 58 can be removed from the backward direction Y2. The inversion section 58 may be removable from the backward direction Y2 when the main body 21 is positioned in the closed position. When the inversion section 58 is detached, the medium jammed in the inversion section 58 can be removed.

### Access to Recording Device 11

As shown in FIGS. 6 to 9, the plurality of recording devices 11 can be housed in the first accommodation section 71 of the carry case 100 in a state of being stacked in the vertical direction Z. The carry case 100 is configured to facilitate access to the plurality of recording devices 11 when the first opening and closing door 61 and the second opening and closing door 62 are in an open state.

Specifically, in a state where the first opening and closing door 61 is open, the operation section 34 can be operated in the plurality of recording devices 11 housed in the first accommodation section 71. In a state where the first opening and closing door 61 is open, the display section 35 in the plurality of recording devices 11 housed in the first accommodation section 71 can be visually checked. In a state where the first opening and closing door 61 is open, the opening and closing section 37 can be opened and closed. In a state where the first opening and closing door 61 is open, the sheet discharge tray 37B can expand and contract in the front-rear direction Y.

In a state where the first opening and closing door 61 is open, it is possible to perform an operation of pulling out the main bodies 21 of the plurality of recording devices 11 housed in the first accommodation section 71. By this, it is possible to perform a maintenance operation on the plurality of recording devices 11 housed in the first accommodation section 71.

As a specific example, as a maintenance operation, a pouring operation in which liquid is poured into the liquid container 40 can be performed. In a case where the liquid container 40 is configured to be attachable and detachable, an operation of attaching and detaching the liquid container 40 can be performed as the maintenance operation. As the maintenance operation, the attaching and detaching operation of the waste liquid container 46 can be performed. As the maintenance operation, for example, a medium that is jammed around the vicinity or the like of the recording section 48 in the transport path 49 can be removed.

In a state where the second opening and closing door 62 is open, the plurality of recording devices 11 housed in the first accommodation section 71 can be operated. As a specific example, an operation of coupling a power supply cable to a power supply terminal provided on the rear surface 13 of the recording device 11 can be performed.

In a state where the second opening and closing door 62 is open, maintenance operations on a plurality of recording devices 11 housed in the first accommodation section 71 can be performed. As a specific example, the inversion section 58 can be removed from the main body 21. By this, a medium that is jammed around the vicinity or the like of the inversion section 58 in the transport path 49 can be removed.

### Operation and Effects of First Embodiment

Operations and effects of the first embodiment will be described.

(1) In the carry case 100, the plurality of recording devices 11 can be housed in the first accommodation section 71 in a state of being stacked in plurality of tiers in the vertical direction Z, and the power supply device 91 can be housed in the second accommodation section 72. By this, the carry case 100 in which the plurality of recording devices 11 and the power supply device 91 are housed, using the wheels 63, can be transported. Therefore, it is possible to improve user convenience.

(2) In the carry case 100, electric power from the power supply device 91 housed in the second accommodation section 72 can be supplied to the plurality of recording devices 11 housed in the first accommodation section 71 in a state of being stacked in the plurality of tiers in the vertical direction Z. By this, by transporting the carry case 100, an environment, in which the plurality of recording devices 11 are used, can be arranged. Therefore, it is possible to improve user convenience.

(3) A first opening and closing door 61 is provided on the case front surface 100A that can be opened and closed. A second opening and closing door 62 is provided on the case rear surface 100B, which can be opened and closed. By this, while the first opening section 60A and the second opening section 60B of the housing main body 60 can be closed, access to the inside of the housing main body 60 can be facilitated. Therefore, it is possible to improve user convenience.

(4) The first accommodation region 71B is arranged further in an upward direction Z1 than the second accommodation region 72B. By this, it is possible to improve operability with respect to the plurality of recording devices 11 housed in the first accommodation region 71B. Therefore, it is possible to improve user convenience.

(5) By expanding the table 65 from storage position P11 to expansion position P12, the table 65 can be used in various ways. Therefore, it is possible to improve user convenience.

(6) When the table 65 is expanded from the storage position P11 to the expansion position P12, the table 65 can be supported by the opened the first opening and closing door 61 and the second opening and closing door 62. By this, the table 65 can be used stably. Therefore, it is possible to improve user convenience.

(7) When the table 65 is expanded from the storage position P11 to the expansion position P12, the object to be placed can be placed on the second placement surface 65B. Therefore, it is possible to improve user convenience.

(8) By adjusting the height using the adjuster 66, the first opening and closing door 61 and the second opening and closing door 62 can be supported from the downward direction Z2. By this, the table 65 can be used stably. Therefore, it is possible to improve user convenience.

(9) When the user grips the grip section 64, the operability of the carry case 100 can be improved. In particular, the housing main body 60 can be easily inclined by gripping the grip section 64, and the operability of the carry case 100 can be improved. Therefore, it is possible to improve user convenience.

(10) By opening the first opening and closing door 61, it is possible to perform maintenance operations on the plurality of recording devices 11 housed in the first accommodation section 71 from the case front surface 100A side. Therefore, it is possible to improve user convenience.

(11) By opening the second opening and closing door 62, it is possible to perform maintenance operations on the plurality of recording devices 11 housed in the first accommodation section 71 from the case rear surface 100B side. Therefore, it is possible to improve user convenience.

(12) By opening the first opening and closing door 61, the operation of pulling out the main bodies 21 of the plurality of recording devices 11 housed in the first accommodation section 71 can be performed from the case front surface 100A side. Therefore, it is possible to improve user convenience.

(13) The first opening and closing door 61 can be locked by the first locking section 67A. The second opening and closing door 62 can be locked by the second locking section 67B. By this, the security of the carry case 100 can be improved. Therefore, it is possible to improve user convenience.

(14) The illumination section 68 illuminates the inside of the housing main body 60. Therefore, the visual checking ability about inside of the housing main body 60 can be improved. Therefore, it is possible to improve user convenience.

(15) The wheels 63 can be driven by the driving force from the drive section 69 housed in the second accommodation section 72. By this, the operability of the carry case 100 can be improved. Therefore, it is possible to improve user convenience.

(16) Even in a case where the housing main body 60 is inclined at a predetermined angle, it is possible to horizontally maintain the plurality of recording devices 11 which are housed in the first accommodation section 71. By this, it is possible to suppress the liquid from leaking from at least one or more the plurality of recording devices 11. Therefore, it is possible to improve user convenience.

(17) In a case where the plurality of recording devices 11 is mounted in a state of being stacked in the plurality of tiers in the vertical direction Z, the plurality of recording devices 11 can be maintained horizontally by the guide section 74 guiding the first placement section 71A. By this, it is possible to suppress the liquid from leaking from at least one or more the plurality of recording devices 11. Therefore, it is possible to improve user convenience.

(18) At the time of recording on medium, in a case where the housing main body 60 is arranged horizontally, the first placement section 71A is fixed to the guide section 74 at a position where the horizontal is maintained by the second fixing section 75. By this, it is possible to suppress a decrease in recording accuracy on the medium. Therefore, it is possible to improve user convenience.

(19) The distances between the guide section 74 and the first placement section 71A can be maintained within a permissible range. By this, even when vibration is applied to the carry case 100, it is possible to prevent the first placement section 71A from being separated from the guide section 74. Therefore, the operability of the carry case 100 can be improved. Therefore, it is possible to improve user convenience.

### MODIFIED EXAMPLES

The present embodiment can be implemented with the following modifications. The present embodiment and the following modified examples can be implemented in combination with each other as long as there is no technical contradiction.
The second fixing section 75 may be provided at any position. The second fixing section 75 may be configured to be insertable and removable by a user's operation on the top surface of the first placement section 71A. The second fixing section 75 may be insertable and removable along the widthwise direction X, or may be insertable and removable along the front-rear direction Y. The second fixing section 75 may fix the plurality of recording devices 11 to the first placement section 71A by coming into contact with the plurality of recording devices 11 from the upward direction Z1. In such a case, the first placement section 71A is fixed to the guide section 74.
The carry case 100 may include a biasing section that biases the plurality of recording devices 11 placed on the first placement section 71A from the upward direction Z1 side to the first placement section 71A. In this way, the first placement section 71A is biased toward the guide section 74 by the biasing force from the biasing section. By this, the distance between the guide section 74 and the first placement section 71A is maintained within the permissible range.
At least one of the surfaces of the guide groove 74A and the rotator 71C may be formed of an elastic component so as to absorb vibration in the vertical direction Z. More specifically, the surface of the guide groove 74A and the surface of the rotator 71C may be formed of an elastic material such as rubber.
The housing main body 60 may include a housing space for housing the wheels 63 on the downward direction Z2 side. That is, a part of the wheels 63 may be housed in the housing space of the housing main body 60.
The first opening and closing door 61 and the second opening and closing door 62 may include a window section through which the inside of the carry case 100 can be visually checked from the outside. The window section is translucent. By this, the states of the recording device 11 and the power supply device 91 housed in the carry case 100 can be visually checked from the outside of the carry case 100 through the window section. In particular, the display content of the display section 35 of the recording device 11 housed in the carry case 100 can be visually checked from the outside of the carry case 100 through the window section.
The table 65 may be slidable between the storage position P11 and the expansion position P12. The table 65 may include a support member for being supported by the installation surface 99. In this case, the table 65 may not be supported by the opened first opening and closing door 61 and the opened second opening and closing door 62.
The first opening and closing door 61 may include the plurality of adjusters 66. The second opening and closing door 62 may include the plurality of adjusters 66. The carry case 100 may not include the adjuster 66.
The first opening and closing door 61 and the second opening and closing door 62 may be biparting doors on the first widthwise direction X1 side and the second widthwise direction X2 side of the housing main body 60. The first opening and closing door 61 and the second opening and closing door 62 may be openable and closable by a rotation shaft along the widthwise direction X. The first opening and closing door 61 and the second opening and closing door 62 may be sliding doors. The first opening and closing door 61 and the second opening and closing door 62 may be able to place the object to be placed to be placed when opened.
The carry case 100 may include a third accommodation section in addition to the first accommodation section 71 and the second accommodation section 72. The third accommodation section may be provided between the first accommodation section 71 and the second accommodation section 72 in the vertical direction Z. The third accommodation section may be provided in a downward direction Z2 than the second accommodation section 72 or may be provided in an upward direction Z1 than the first accommodation section 71. The third accommodation section may be provided so as to be aligned with the second accommodation section 72 in the widthwise direction X. The first accommodation section 71 may be positioned in a downward direction 22 lower than the second accommodation section 72.
The second accommodation section 72 may be able to house a component other than the power supply device 91. The second accommodation section 72 may be able to accommodate maintenance supplies for performing maintenance. As a specific example, the second accommodation section 72 may be able to house a liquid accommodation body such as an ink bottle or a replacement ink cartridge. The second accommodation section 72 may be able to house a waste liquid container such as a replacement waste liquid tank.
The carry case 100 may be constituted of any material. As a specific example, the carry case 100 may be made of, for example, aluminum, duralumin, polycarbonate, or polypropylene, or may be made of cloth and a core material.
A lateral type printer may be adopted as the recording device 11. The lateral type printer is a printer in which carriage 51 can move in two directions of the main scanning direction and the sub-scanning direction.
The medium may be any medium, and may be, for example, paper sheet, a resin film or sheet, a composite film of a resin and a metal, a laminate film, roll paper, a woven fabric, a nonwoven fabric, a metal foil, a metal film, a ceramic sheet, or clothing.
The liquid can be arbitrarily selected as long as it can adhere to the medium to perform recording on the medium. For example, the ink includes an ink in which particles of a functional material made of a solid material such as a pigment or metal particles are dissolved, dispersed, or mixed in a solvent and includes various compositions such as a water-based ink, an oil-based ink, a gel ink, and a hot-melt ink.
As used herein, the phrase “at least one of” means one or more of the desired options. As an example, the phrase “at least one of” as used herein means only one option if the number of options is two, or both of the two options. As another example, the phrase “at least one of” as used herein means only one option or any combination of two or more options, as long as the number of options is three or more.

### NOTES

Hereinafter, technical ideas grasped from the above-described embodiment and modified examples, and operational effects thereof will be described. The present technical idea and the operational effects thereof can be combined with each other within a technically consistent range.

(A1) A carry case includes a housing main body; a first accommodation section configured to accommodate, in a first accommodation region within the housing main body, a plurality of recording devices in a state of being stacked in a plurality of tiers in a vertical direction; a second accommodation section configured to accommodate, in the housing main body in a second accommodation region that is aligned in the vertical direction with the first accommodation region, a power supply device that supplies electric power to the plurality of recording devices; a first opening and closing door configured to open and close in a first surface of the housing main body; a second opening and closing door configured to open and close in a second surface opposite to the first surface of the housing main body; and a wheel that is below the housing main body and that enables moving the housing main body.

According to this configuration, the carry case can house the plurality of recording devices in a state of being stacked in plurality of tiers in the vertical direction in the first accommodation section and can house the power supply device in the second accommodation section. By this, the carry case housing the plurality of recording devices and the power supply device can be transported using the wheels. Therefore, it is possible to improve user convenience.

In the carry case, it is possible to supply electric power from the power supply device housed in the second accommodation section to the plurality of recording devices housed in the first accommodation section in a state of being stacked in the plurality of tiers in the vertical direction. By this, it is possible to prepare an environment in which plurality of recording devices are used by transporting the carry case. Therefore, it is possible to improve user convenience.

A first opening and closing door is provided to be openable and closable on the first surface, and a second opening and closing door is provided to be openable and closable on the second surface. By this, the inside of the housing main body can be shielded, and access to the inside of the housing main body can be facilitated. Therefore, it is possible to improve user convenience.

(A2) The carry case may further include a table provided above the housing main body, wherein the table is expandable from a storage position to an expansion position and, when the table is expanded to the expansion position, may be supported by the opened first opening and closing door and the opened second opening and closing door.

According to this configuration, it is possible to diversify the use of the table by expanding it from the storage position to the expansion position. Therefore, it is possible to improve user convenience.

Further, when the table is expanded from the storage position to the expansion position, the table can be supported by the opened first opening and closing door and the opened second opening and closing door. By this, it is possible to stably use the table. Therefore, it is possible to improve user convenience.

(A3) In the above carry case, the table may have a placement surface on which an object to be placed can be placed when the table is expanded to the expansion position.

According to this configuration, when the table is expanded from the storage position to the expansion position, the object to be placed can be placed on the placement surface. Therefore, it is possible to improve user convenience.

(A4) The carry case may include an adjuster configured to, when the table is expanded to the expansion position, adjust the height below the first opening and closing door and below the second opening and closing door.

According to this configuration, the adjustment of the height of the adjuster can support the first opening and closing door and the second opening and closing door from the downward direction. By this, it is possible to stably use the table. Therefore, it is possible to improve user convenience.

(A5) The carry case may include a grip section that can be gripped by a user.

According to this configuration, since the grip section is gripped by the user, it is possible to improve the operability of the carry case. Therefore, it is possible to improve user convenience.

(A6) In the carry case, the first opening and closing door may be configured to open and close at least a part of the first accommodation region and in a state where the first opening and closing door is open, maintenance operations may be performable on the plurality of recording devices accommodated in the first accommodation section.

According to this configuration, by opening the first opening and closing door, it is possible to perform maintenance operations on the plurality of recording devices housed in the first accommodation section from the first surface side. Therefore, it is possible to improve user convenience.

(A7) In the carry case, the second opening and closing door is configured to open and close at least a part of the first accommodation region, and in a state where the second opening and closing door is open, maintenance operations may be performable on the plurality of recording devices accommodated in the first accommodation section.

According to this configuration, by opening the second opening and closing door, it is possible to perform maintenance operations on the plurality of recording devices housed in the first accommodation section from the second surface side. Therefore, it is possible to improve user convenience.

(A8) In the carry case, the first opening and closing door is configured to open and close at least a part of the first accommodation region and the main bodies of the plurality of recording devices housed in the first accommodation section may be configured to be pulled out in a state where the first opening and closing door is open.

According to this configuration, by opening the first opening and closing door, it is possible to perform an operation of pulling out the main bodies of the plurality of recording devices housed in the first accommodation section from the first surface side. Therefore, it is possible to improve user convenience.

The carry case may include a first locking section configured to lock the first opening and closing door in a state in which the first opening and closing door is closed and a second locking section configured to lock the second opening and closing door in a state in which the second opening and closing door is closed.

According to this configuration, the first opening and closing door and the second opening and closing door can be locked. By this, it is possible to improve the security of the carry case. Therefore, it is possible to improve user convenience.

(A10) The carry case may include an illumination section configured to illuminate the inside of the housing main body.

According to this configuration, the visual checking ability about inside of the housing main body can be improved. Therefore, it is possible to improve user convenience.

(A11) The carry case may include a drive section configured to drive the wheels, wherein the drive section may be configured to be accommodated in the second accommodation section.

According to this configuration, the wheels can be driven by housing the drive section in the second accommodation section. By this, the operability of the carry case can be improved. Therefore, it is possible to improve user convenience.

The recording system includes a plurality of recording devices; a power supply device configured to supply power to the plurality of recording devices; and a carry case configured to accommodate the plurality of recording devices and the power supply device, wherein the carry case has a housing main body; a first accommodation section configured to accommodate the plurality of recording devices in a state of being stacked in a plurality of tiers in a vertical direction in the first accommodation region in the housing main body, a second accommodation section configured to house the power supply device in a second accommodation region aligned with the first accommodation region in the vertical direction in the housing main body, a first opening and closing door configured to open and close in a first surface of the housing main body; a second opening and closing door configured to open and close in a second surface opposite to the first surface of the housing main body; and a wheel that is below the housing main body and that enables moving the housing main body. According to this configuration, the same effect as that of the A1 can be achieved.

(B1) A carry case includes a housing main body; a first accommodation section configured to accommodate a plurality of recording devices in a state of being stacked in a plurality of tiers in a vertical direction in a first accommodation region within the housing main body, the recording devices performing recording by ejecting liquid; a second accommodation section configured to accommodate, in the housing main body in a second accommodation region that is aligned in the vertical direction with the first accommodation region, a power supply device that supplies electric power to the plurality of recording devices; a wheel that is below the housing main body and that enables moving the housing main body; and a horizontal maintaining section configured to, when the housing main body is inclined at a predetermined angle, horizontally support the plurality of recording devices accommodated in the first accommodation section.

According to this configuration, it can house the plurality of recording devices in a state of being stacked in plurality of tiers in the vertical direction in the first accommodation section and can house the power supply device in the second accommodation section. By this, the carry case housing the plurality of recording devices and the power supply device can be transported using the wheels. Therefore, it is possible to improve user convenience.

In addition, it is possible to supply electric power from the power supply device housed in the second accommodation section to the plurality of recording devices housed in the first accommodation section in a state of being stacked in plurality of tiers in the vertical direction. By this, it is possible to prepare an environment in which plurality of recording devices are used by transporting the carry case. Therefore, it is possible to improve user convenience.

Even when the housing main body is inclined at a predetermined angle, the plurality of recording devices accommodated in the first accommodation section can be maintained horizontally. By this, it is possible to suppress the liquid from leaking from at least one or more the plurality of recording devices. Therefore, it is possible to improve user convenience.

(B2) In the carry case, the horizontal maintaining section, when the housing main body is inclined at a predetermined angle, does not need to horizontally support the power supply device housed in the second accommodation section.

According to this configuration, when the housing main body is inclined at the predetermined angle, the power supply device housed in the second accommodation section is not supported horizontally. By this, it possible to reduce the size and weight of the carry case. Therefore, the carry case can be easily transported. Therefore, it is possible to improve user convenience.

(B3) In the carry case, the second accommodation section may include a second placement section that places the power supply device and a first fixing section that fixes the position of the power supply device placed on the second placement section.

According to this configuration, when the housing main body is inclined at the predetermined angle, the power supply device housed in the second accommodation section is not supported horizontally. However, the power supply device can be fixed to the second placement section by the first fixing section. By this, the power supply device can be stably transported. Therefore, the carry case can be easily transported. Therefore, it is possible to improve user convenience.

(B4) The carry case may further include a first opening and closing door configured to open and close in a first surface of the housing main body and a second opening and closing door configured to open and close in a second surface opposite to the first surface of the housing main body.

According to this configuration, the first opening and closing door is provided on the first surface so as to be openable and closable, and the second opening and closing door is provided on the second surface so as to be openable and closable. By this, the inside of the housing main body can be shielded, and access to the inside of the housing main body can be facilitated. Therefore, it is possible to improve user convenience.

(B5) In the carry case, the first opening and closing door is configured to open and close at least a part of the first accommodation region and in a state where the first opening and closing door is open, maintenance operations may be performable on the plurality of recording devices accommodated in the first accommodation section.

According to this configuration, by opening the first opening and closing door, it is possible to perform maintenance operations on the plurality of recording devices housed in the first accommodation section from the first surface side. Therefore, it is possible to improve user convenience.

(B6) In the carry case, the second opening and closing door is configured to open and close at least a part of the first accommodation region, and in a state where the second opening and closing door is open, maintenance operations may be performable on the plurality of recording devices accommodated in the first accommodation section.

According to this configuration, by opening the second opening and closing door, it is possible to perform maintenance operations on the plurality of recording devices housed in the first accommodation section from the second surface side. Therefore, it is possible to improve user convenience.

(B7) In the carry case, the first opening and closing door is configured to open and close at least a part of the first accommodation region and the main bodies of the plurality of recording devices housed in the first accommodation section may be configured to be pulled out in a state where the first opening and closing door is open.

According to this configuration, by opening the first opening and closing door, it is possible to perform an operation of pulling out the main bodies of the plurality of recording devices housed in the first accommodation section from the first surface side. Therefore, it is possible to improve user convenience.

(B8) The carry case may further include a first locking section configured to lock the first opening and closing door in a state in which the first opening and closing door is closed and a second locking section configured to lock the second opening and closing door in a state in which the second opening and closing door is closed.

According to this configuration, the first opening and closing door and the second opening and closing door can be locked. By this, it is possible to improve the security of the carry case. Therefore, it is possible to improve user convenience.

(B9) The carry case may further include a table provided above the housing main body, wherein the table is expandable from a storage position to an expansion position and, when the table is expanded to the expansion position, may be supported by the opened first opening and closing door and the opened second opening and closing door.

According to this configuration, it is possible to diversify the use of the table by expanding it from the storage position to the expansion position. Therefore, it is possible to improve user convenience.

Further, when the table is expanded from the storage position to the expansion position, the table can be supported by the opened first opening and closing door and the opened second opening and closing door. By this, it is possible to stably use the table. Therefore, it is possible to improve user convenience.

(B10) In the above carry case, the table may have a placement surface on which an object to be placed is placeable when the table is expanded to the expansion position.

According to this configuration, when the table is expanded from the storage position to the expansion position, the object to be placed can be placed on the placement surface. Therefore, it is possible to improve user convenience.

(B11) The carry case may further include an adjuster configured to, when the table is expanded to the expansion position, adjust the height below the first opening and closing door and below the second opening and closing door.

According to this configuration, the adjustment of the height of the adjuster can support the first opening and closing door and the second opening and closing door from the downward direction. By this, it is possible to stably use the table. Therefore, it is possible to improve user convenience.

(B12) The carry case may further include a grip section that can be gripped by a user.

According to this configuration, the user can easily transport the carry case by holding the grip section. Therefore, it is possible to improve user convenience.

(B13) The carry case may further include an illumination section configured to illuminate the inside of the housing main body.

According to this configuration, the visual checking ability about inside of the housing main body can be improved. Therefore, it is possible to improve user convenience.

(B14) The carry case may further include a drive section configured to drive the wheels, wherein the drive section may be configured to be accommodated in the second accommodation section.

According to this configuration, the wheels can be driven by housing the drive section in the second accommodation section. By this, the carry case can be easily transported. Therefore, it is possible to improve user convenience.

(B15) In the carry case, the first accommodation section includes a first placement section on which the plurality of recording devices are placeable in a state of being stacked in plurality of tiers in the vertical direction, the horizontal maintaining section includes a guide section that guides the first placement section and a second fixing section that fixes the first placement section to the guide section, the guide section is fixed to the housing main body and, when the housing main body is inclined at a predetermined angle, guides the first placement section to keep the first placement section horizontal, and when the housing main body is arranged horizontally, the second fixing section may fix the first placement section to the guide section at a position at which the first placement section is kept horizontal.

According to this configuration, it is possible to horizontally maintain the plurality of recording devices by guiding the first placement section in a state in which the plurality of recording devices is mounted in a state of being stacked in plurality of tiers in the vertical direction. By this, it is possible to suppress the liquid from leaking from at least one or more the plurality of recording devices. Therefore, it is possible to improve user convenience.

When the housing main body is horizontally arranged at the time of recording on the medium, the first placement section is fixed to the guide section at a position at which the first placement section is maintained to be horizontal. By this, it is possible to suppress a decrease in recording accuracy on the medium. Therefore, it is possible to improve user convenience.

(B16) In the carry case, the first accommodation section includes a first placement section on which the plurality of recording devices are placeable in a state of being stacked in plurality of tiers in the vertical direction, the horizontal maintaining section includes a guide section that guides the first placement section, the guide section is fixed to the housing main body and, when the housing main body is inclined at a predetermined angle, guides the first placement section to keep the first placement section horizontal, and the carry case may be configured so as to maintain a distance between the guide section and the first placement section within an permissible range.

According to this configuration, it is possible to horizontally maintain the plurality of recording devices by guiding the first placement section in a state in which the plurality of recording devices is mounted in a state of being stacked in plurality of tiers in the vertical direction. By this, it is possible to suppress the liquid from leaking from at least one or more the plurality of recording devices. Therefore, it is possible to improve user convenience.

The distance between the guide section and the first placement section can be maintained within an permissible range. By this, even when vibration is applied to the carry case, it is possible to suppress the first placement section from being separated from the guide section. Therefore, the carry case can be easily transported.

Therefore, it is possible to improve user convenience.

(B17) The recording system includes a plurality of recording devices for performing printing by ejecting liquid; a power supply device configured to supply power to the plurality of recording devices; and a carry case configured to accommodate the plurality of recording devices and the power supply device; wherein the carry case has a housing main body, a first accommodation section configured to accommodate the plurality of recording devices in a state of being stacked in a plurality of tiers in a vertical direction in the first accommodation region in the housing main body, a second accommodation section configured to house the power supply device in a second accommodation region aligned with the first accommodation region in the vertical direction in the housing main body, a wheel that is below the housing main body and that enables moving the housing main body; and a horizontal maintaining section configured to, when the housing main body is inclined at a predetermined angle, horizontally support the plurality of recording devices accommodated in the first accommodation section. According to this configuration, the same effect as that of B1 can be achieved.

What is claimed is:

1. A carry case comprising:
a housing main body;
a first accommodation section configured to accommodate, in a first accommodation region within the housing main body, a plurality of recording devices in a state of being stacked in a plurality of tiers in a vertical direction;
a second accommodation section configured to accommodate, in the housing main body in a second accommodation region that is aligned in the vertical direction with the first accommodation region, a power supply device that supplies electric power to the plurality of recording devices;
a first opening and closing door configured to open and close in a first surface;
a second opening and closing door configured to open and close in a second surface that is opposite from the first surface; and
a wheel that is below the housing main body and that enables moving the housing main body.

2. The carry case according to claim 1, further comprising:
a table provided above the housing main body, wherein
the table is expandable from a storage position to an expansion position and, when the table is expanded to the expansion position, is supported by the opened first opening and closing door and the opened second opening and closing door.

3. The carry case according to claim 2, wherein
the table has a placement surface on which an object to be placed is placeable when the table is expanded to the expansion position.

4. The carry case according to claim 3, further comprising:
an adjuster configured to, when the table is expanded to the expansion position, adjust the height below the first opening and closing door and below the second opening and closing door.

5. The carry case according to claim 1, further comprising:
a grip section configured to be gripped by a user.

6. The carry case according to claim 1, wherein
the first opening and closing door is configured to open and close at least a part of the first accommodation region and
in a state where the first opening and closing door is open, maintenance operations are performable on the plurality of recording devices accommodated in the first accommodation section.

7. The carry case according to claim 1, wherein
the second opening and closing door is configured to open and close at least a part of the first accommodation region, and
in a state where the second opening and closing door is open, maintenance operations are performable on the plurality of recording devices accommodated in the first accommodation section.

8. The carry case according to claim 1, wherein
the first opening and closing door is configured to open and close at least a part of the first accommodation region and
the main bodies of the plurality of recording devices housed in the first accommodation section are configured to be pulled out in a state where the first opening and closing door is open.

9. The carry case according to claim 1, further comprising:
a first locking section configured to lock the first opening and closing door in a state in which the first opening and closing door is closed and
a second locking section configured to lock the second opening and closing door in a state in which the second opening and closing door is closed.

10. The carry case according to claim 1, further comprising:
an illumination section configured to illuminate the inside of the housing main body.

11. The carry case according to claim 1, further comprising:
a drive section configured to drive the wheel, wherein
the drive section is configured to be accommodated in the second accommodation section.

12. A carry case comprising:
a housing main body;
a first accommodation section configured to accommodate a plurality of recording devices in a state of being stacked in a plurality of tiers in a vertical direction in a first accommodation region within the housing main body, the recording devices performing recording by ejecting liquid;
a second accommodation section configured to accommodate, in the housing main body in a second accommodation region that is aligned in the vertical direction with the first accommodation region, a power supply device that supplies electric power to the plurality of recording devices;
a wheel that is below the housing main body and that enables moving the housing main body; and
a horizontal maintaining section configured to, when the housing main body is inclined at a predetermined angle, horizontally support the plurality of recording devices accommodated in the first accommodation section.

13. The carry case according to claim 12, wherein
when the housing main body is inclined at a predetermined angle, the horizontal maintaining section does not horizontally support the power supply device housed in the second accommodation section.

14. The carry case according to claim 12, wherein
the second accommodation section includes
a second placement section on which the power supply device is placeable and
a first fixing section that fixes the position of the power supply device placed on the second placement section.

15. The carry case according to claim 12, wherein
the first accommodation section includes a first placement section on which the plurality of recording devices are placeable in a state of being stacked in plurality of tiers in the vertical direction,
the horizontal maintaining section includes a guide section that guides the first placement section and a second fixing section that fixes the first placement section to the guide section,
the guide section is fixed to the housing main body and, when the housing main body is inclined at a predetermined angle, guides the first placement section to keep the first placement section horizontal, and
when the housing main body is arranged horizontally, the second fixing section fixes the first placement section to the guide section at a position at which the first placement section is kept horizontal.

16. The carry case according to claim 12, wherein
the first accommodation section includes a first placement section on which the plurality of recording devices are placeable in a state of being stacked in plurality of tiers in the vertical direction,
the horizontal maintaining section includes a guide section that guides the first placement section,
the guide section is fixed to the housing main body and, when the housing main body is inclined at a predetermined angle, guides the first placement section to keep the first placement section horizontal, and
the carry case is configured so as to maintain a distance between the guide section and the first placement section within an permissible range.

17. A recording system comprising:
a plurality of recording devices;
a power supply device configured to supply power to the plurality of recording devices;
a carry case configured to accommodate the plurality of recording devices and the power supply device, wherein
the carry case includes
a housing main body,
a first accommodation section configured to accommodate the plurality of recording devices in a state of being stacked in a plurality of tiers in a vertical direction in the first accommodation region in the housing main body,
a second accommodation section configured to house the power supply device in a second accommodation region aligned with the first accommodation region in the vertical direction in the housing main body,
a first opening and closing door configured to open and close in a first surface,
a second opening and closing door configured to open and close in a second surface opposite to the first surface, and
a wheel that is below the housing main body and that enables moving the housing main body.
